(19) United States
(12) Patent Application Publication
(10) Pub. No.: US 2014/0220527 A1
(43) Pub. Date: Aug. 7, 2014

(54) Video-Based System for Improving Surgical Training by Providing Corrective Feedback on a Trainee's Movement

(71) Applicants: Baoxin Li, Chandler, AZ (US); Peng Zhang, Tempe, AZ (US); Qiang Zhang, Tempe, AZ (US); Lin Chen, Tempe, AZ (US)

(72) Inventors: Baoxin Li, Chandler, AZ (US); Peng Zhang, Tempe, AZ (US); Qiang Zhang, Tempe, AZ (US); Lin Chen, Tempe, AZ (US)

(73) Assignee: AZ Board of Regents, a body corporate of the State of AZ, acting for & on behalf of AZ State, Scottsdale, AZ (US)

(21) Appl. No.: 14/174,372

(22) Filed: Feb. 6, 2014

Related U.S. Application Data
(60) Provisional application No. 61/761,917, filed on Feb. 7, 2013.

(51) Int. Cl. G09B 9/00

(52) U.S. Cl. CPC G09B 9/00
USPC 434/262

(57) ABSTRACT

An intelligent system that supports real-time and offline feedback based on automated analysis of a trainee's performance using data streams captured in the training process is disclosed.

### CROSS-REFERENCE TO RELATED APPLICATIONS

This application claims priority to U.S. Provisional Application No. 61/761,917 filed Feb. 7, 2013, the entire contents of which is specifically incorporated by reference herein without disclaimer.

### STATEMENT REGARDING FEDERALLY SPONSORED RESEARCH OR DEVELOPMENT

This invention was made with government support under Grant No. IIS-0904778 awarded by the National Science Foundation. The government has certain rights in the invention.

### BACKGROUND OF THE INVENTION

1. Field of the Invention

The present invention relates generally to video analysis. More particularly, it relates to automated video analysis for improving surgical training in laparoscopic surgery.

2. Description of Related Art

Laparoscopic surgery has become popular for its potential advantages of a shorter hospital stay, a lower risk of infection, a smaller incision, etc. Compared with open surgery, laparoscopic surgery requires surgeons to operate in a small space from a small incision by watching a monitor capturing the inside of the body. Hence a new set of cognitive and motor skills are needed from a surgeon. Among others, the Fundamentals of Laparoscopic Surgery (FLS) Program was developed by the Society of American Gastrointestinal and Endoscopic Surgeons to help training qualified laparoscopic surgeons. The key tool used in this program is the FLS Trainer Box, which supports a set of predefined tasks. The box has been widely used in many hospitals/training centers across the country. Although the box has seen a lot of adoption, its functionality is limited especially in that it is mostly a passive platform for a trainee to practice on, and it does not provide any feedback to a trainee during the training process. Senior surgeons may be invited to watch a trainee's performance to provide feedback. However, that would be a costly option that cannot be readily available at any time the trainee is practicing.

### SUMMARY OF THE INVENTION

In accordance with an exemplary embodiment, a method of providing training comprises receiving at least one video stream from a video camera observing a trainee's movements, processing the at least one video stream to extract skill-related attributes, and displaying the video stream and the skill-related attributes.

The skill-related attributes may be displayed on a display in real-time.

The method may also include receiving at least one data stream from a data glove and processing the at least one data stream from the data glove to extract skill-related attributes.

The method may also include receiving at least one data stream from a motion tracker and processing the at least one data stream from the motion tracker to extract skill-related attributes.

The extracted attributes may comprise motion features in a region of interest, and the motion features may comprise spatial motion, radial motion, relative motion, angular motion and optic flow.

The step of processing the at least one video stream may utilize a random forest model.

In accordance with another exemplary embodiment, an apparatus for training a trainee comprises a laparoscopic surgery simulation system having a first camera and a video monitor, a second camera for capturing a trainee's hand movement, and a computer for receiving video streams from the first and second cameras. The processor of the computer is configured to apply video analysis to the video streams to extract skill-related attributes.

The apparatus may include kinematic sensors for capturing kinematics of the hands and fingers or may include a motion tracker, such as a data glove.

The skill-related attributes may comprise smoothness of motion and acceleration.

In accordance with an exemplary embodiment, a method of providing instructive feedback comprises decomposing a video sequence of a training procedure into primitive action units, and rating each action unit using expressive attributes derived from established guidelines.

An illustrative video may be selected as a reference from a pre-stored database.

A trainee's practice sessions of the training procedure may be stored. Different trainee practice sessions of the training procedure may be compared.

The feedback may be provided live or offline.

The expressive attributes may be selected from the group consisting of hands synchronization, instrument handling, suture handling, flow of operation and depth perception.

The method may also include the steps of identifying worst action attributes of a trainee, retrieving illustrative video clips relating to the worst action attributes, and presenting the illustrative video clips to the trainee.

### BRIEF DESCRIPTION OF THE DRAWINGS

FIG. 1 illustrates a system in accordance with an embodiment of the invention;

FIGS. 2A and 2B illustrate registry and login interfaces, respectively, in accordance with an embodiment of the invention;

FIG. 3 illustrates a training mode interface in accordance with an embodiment of the invention;

FIG. 4 illustrates an analysis mode interface in accordance with an embodiment of the invention;

FIG. 5 illustrates another analysis mode interface in accordance with an embodiment of the invention;

FIG. 6 illustrates a flowchart of a method in accordance with an embodiment of the present invention;

FIG. 7 is an illustration of object-motion distribution for action recognition;

FIG. 8 is a graphical model for Bayesian estimation of transition probability;

FIG. 9 is a conceptual illustration of a surgical skill coaching system in accordance with an embodiment of the invention;

FIG. 10 is a frame-level comparison of action segmentation of a trainee's left-hand operation in video 1 (Table 8) with 12 circles.

FIG. 11 an embodiment of the FLS trainer (left) and a sample frame captured by the on-board camera (right);

FIG. 12 is a sample frame from the data stream (left) and the optical flow computed for the sample frame (right);

FIG. 13 is an example data glove data stream showing one finger joint angle that was used to segment the data; and

FIG. 14 is a graph of acceleration in the first week of training (dotted curve) and the last week of training (solid curve).

### DESCRIPTION OF ILLUSTRATIVE EMBODIMENTS

In the following detailed description, reference is made to the accompanying drawings, in which are shown exemplary but non-limiting and non-exhaustive embodiments of the invention. These embodiments are described in sufficient detail to enable those having skill in the art to practice the invention, and it is understood that other embodiments may be used, and other changes may be made, without departing from the spirit or scope of the invention. The following detailed description is, therefore, not to be taken in a limiting sense, and the scope of the invention is defined only by the appended claims. In the accompanying drawings, like reference numerals refer to like parts throughout the various figures unless otherwise specified.

Following is a disclosure of a video-based skill coaching system for the domain of simulation-based surgical training The system is aimed at providing automated feedback that has the following three features: (i) specific (locating where the errors and defects are); (ii) instructive (explaining why they are defects and how to improve); and (iii) illustrative (providing good examples for reference). Although the focus of the disclosure is on the specific application of simulation-based surgical training, the above features are important to effective skill coaching in general, and thus the proposed method may be extended to other video-based skill coaching applications.

Certain embodiments of the present invention accomplish the following technical tasks and utilize a suite of algorithms developed for addressing these tasks:
Decomposing a video sequence of a training procedure into primitive action units.
Rating each action using expressive attributes derived from established guidelines used by domain experts.
Selecting an illustrative video as a reference from a pre-stored database.

A challenge in these tasks is to map computable visual features to semantic concepts that are meaningful to a trainee. Recognizing the practical difficulty of lacking sufficient amount of exactly labeled data for learning an explicit mapping, we utilize the concept of relative attribute learning for comparing the videos based on semantic attributes designed using domain knowledge.

### Hardware Setup

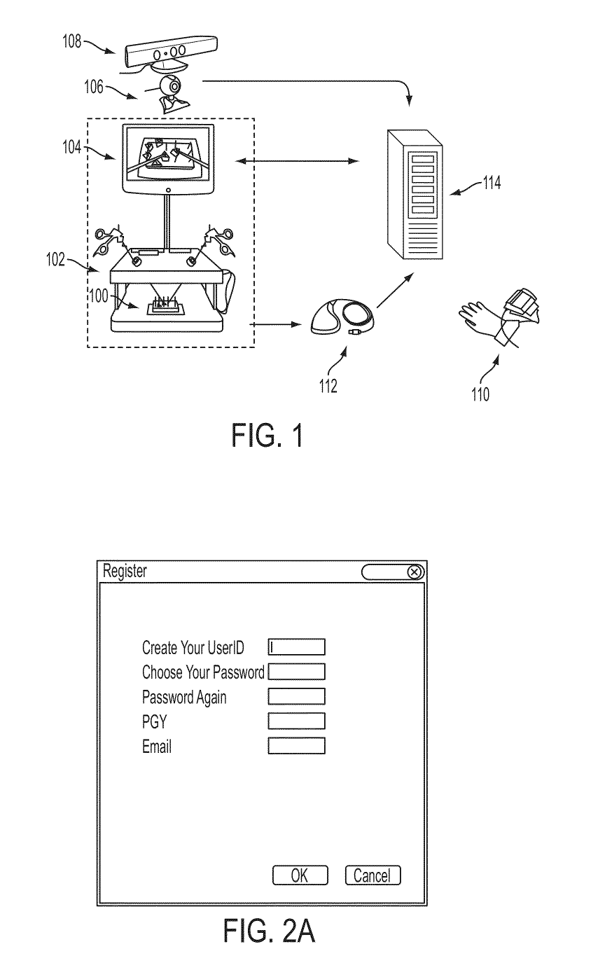

In an embodiment of the system as shown in FIG. 1, the FLS box 100 includes an onboard camera 102 and a video monitor 104. There are two additional cameras beside the FLS box on-board video camera: a USB webcam 106 and a motion sensing input device 108. One example of motion sensing input device 108 is a KINECT™ motion controller available from Microsoft Corporation, Redmond Wash. These devices are employed to capture the trainee's hand movement. Optionally, data gloves 110 with attached motion trackers may be worn by a trainee. These are employed to capture the kinematics of the hands/fingers for more elaborate analysis and feedback if so desired. For kinematic sensors, motion trackers from Polhemus (www.polhemus.com) together with the CyberTouch data glove (www.vrealities.com) may be used. The video from the FLS box video camera 102 is routed through a frame grabber 112 to a computer 114 for analysis while being displayed on the monitor.

### Design of the Interface and Feedback Mechanism

One component of the proposed system in FIG. 1 is the design of the interface and feedback mechanisms, which deals with efficient ways of supporting communication of the results of any automated analysis approaches as feedback to a trainee. The disclosed system addresses the following aspects and corresponding interface schemes.

### Data Archival, Indexing and Retrieval

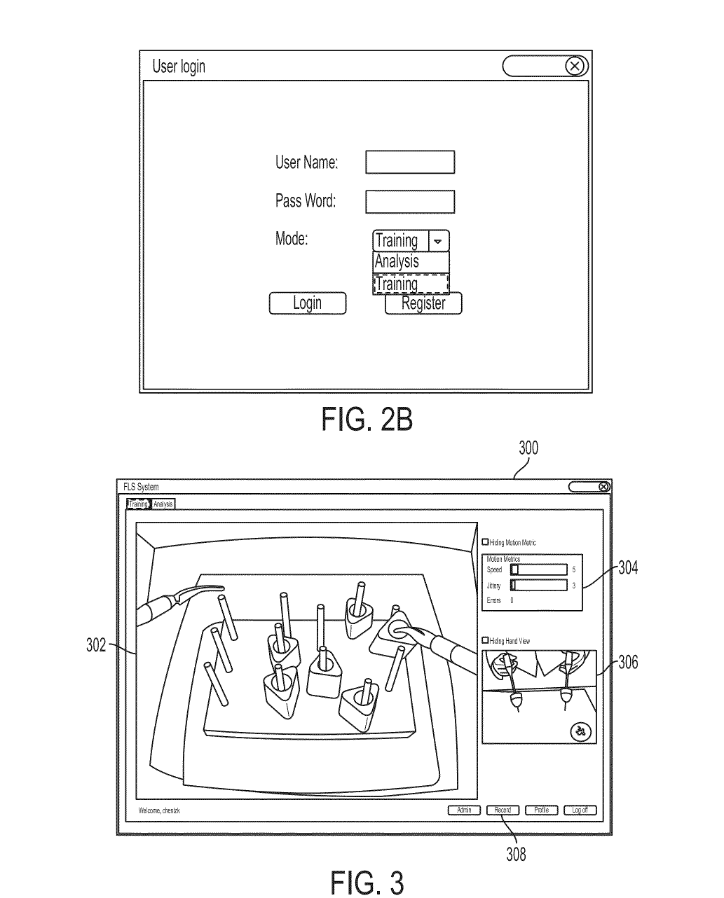

The original FLS box is only a “pass-through” system without memory. The disclosed system stores a trainee's practice sessions, which can be used to support many capabilities including comparison of different sessions, enabling a trainee to review his/her errors, etc. The system may allow users to register so that their actions are associated with their user identification. One example of a registration screen is shown in FIG. 2A, and one example of a login screen is shown in FIG. 2B. Other interfaces, such as administrative tools and user management tools, may also be provided, as is conventional in the art. The system may index and associate any captured stream with the login information for effective retrieval. The system may provide a user with the option of entering the system in training mode or in analysis mode.

### Training Mode

In training mode, a processor in the system may be employed to process the captured streams in real-time and display key skill-related attributes (for example, smoothness of motion and acceleration) on the monitor. FIG. 3 illustrates one example of an interface 300 suitable for use in the training mode of operation. This interface 300 includes three windows: a main window 302, a feedback window 304, and a hand view window 306. Main video window 302 shows the operation of the tool. Feedback window 304 provides real-time feedback, such as operation speed, jitter and the number of errors made in the current training session. Hand view window 306 a view of the user's hands.

At any time, a user may choose to record a training session by pressing a record button 308. The system may provide a short pause before beginning to record to allow a user to prepare (e.g., 5 seconds), and a message or other visible alert may be displayed to indicate that recording is in process. A stop recording button may be provided. It may be a provided by changing the record button into a stop button while recording is in process, and reverting it to a record button when recording is stopped.

Once completed, the training session records are associated with the user and stored for future retrieval.

### Analysis Mode

The system may allow a trainee to compare his/her performance between different practice sessions to provide insights as to how to improve by providing “offline feedback” to the user. This goes beyond simply providing videos from two sessions to the trainee, since computational tools can be used to analyze performance and deliver comparative attributes based on the video.

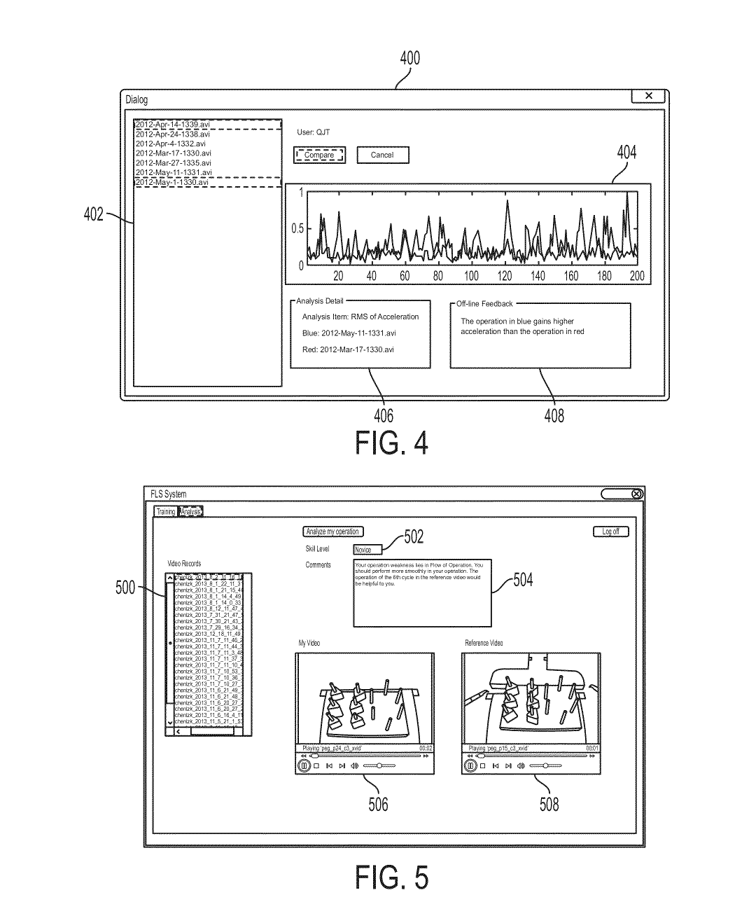

FIG. 4 illustrates an example of an interface 400 to provide feedback by comparing two different sessions of a user. The left panel 402 of the interface lists the previous trials associated with a given user. By selecting two videos, say the first and last ones, the graph window displays computed motion attributes for the two selected sessions, while the text panels below the graph supply other comparative results (computed by an underlying software module described in detail below). In this illustrative embodiment, feedback is provided regarding acceleration of the user's hands in graph format in a window 404. Additional details and feedback are also provided in windows 406, 408. Other presentation formats (including those discussed with reference to FIG. 5) can also be used.

The system may also allow a user to compare performance against a reference video. FIG. 5 illustrates an example of feedback provided by comparing a user's performance against a reference video. In this case, a list of videos associated with a user will be displayed in a panel 500 to allow a user to choose a video for comparison. After analyzing the user's performance using the algorithms described in detail below, the system will provide feedback such as skill level 502, comments 504, and allow the user to simultaneously view the user's performance and the reference video in windows 506, 508.

### Definition of Latent Space

Automatic evaluation of surgical performance of the trainees has been a topic of research for many years. For example, the work has discussed various aspects of the problem, where the criterion for surgical skill evaluation is mostly based on data streams from kinematic devices including data glove and motion tracker. Also, according to studies, there is a high correlation between the proficiency level and the kinematic measurements. While these studies provide the foundation for building a system for objective evaluation of surgical skills, many of the metrics that have been discussed are difficult to obtain from video streams on an FLS box. In other words, there is no straightforward way of applying the criterion directly on the videos captured in an FLS box, which records the effect of the subject's action inside the box (but not directly the hand movements of the trainee).

In accordance with certain embodiments of the present invention, video analysis may be applied to the FLS box videos to extract the skill-defining features. One visual feature for movement analysis is the computed optical flow. Unfortunately, raw optical flow is not only noisy but also merely a 2-D projection of true 3-D motion, which is more relevant for skill analysis. To this end, we define a latent space for the low-level visual feature with the goal of making the inference of surgical skills more meaningful in that space. Recognizing the fact that both the visual feature and the kinematic measurements arise from the same underlying physical movements of the subject and thus they should be strongly correlated, we employ Canonical Correlation Analysis (CCA) to identify the latent space for the visual data.

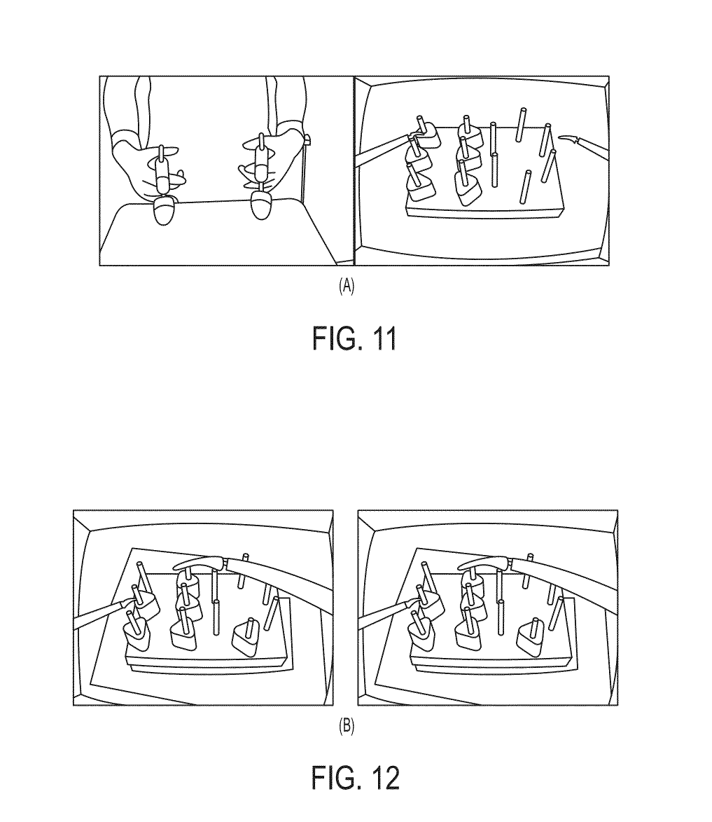

FIG. 11 illustrates how the expanded system was used to collect data: the left figure shows a subject performing a surgical operation on an FLS box, wearing the data gloves (which may be located on the hands) and motion trackers (which may be located on the wrists). The image on the right is a sample frame from the video captured by the on-board camera. This expanded system produces synchronized data streams of three modalities: the video from the on-board camera, the data glove measurements (finger joint angles), and the motion tracker measurements (6 degree-of-freedom motion data of both hands).

With the above system, we collected data for the peg transform operation (discussed in more detail below) based on student participants who had no prior experience on the system (and hence it was reasonably assumed that each participants started as a novice). The data collection lasted for four weeks. In each week, the participants were asked to practice for 3 sessions on different days, and in each session each participant was required to perform the surgical simulation three times consecutively. All subjects were required to attend all the sessions. The synchronized multi-modal streams were recorded for the sessions. The subsequent analysis of the data is based on the recorded streams from 10 participants.

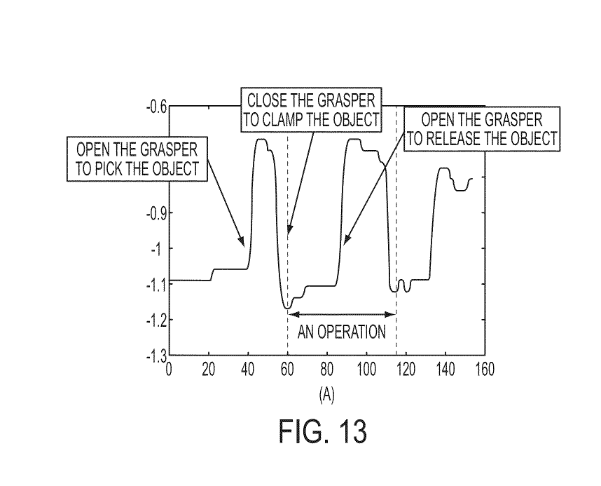

For each subject, the three streams of recorded data in one session are called a record. Due to subject variability, the records may not start with the subjects doing exactly the same action. To alleviate this issue, we first utilized the cycles of the data glove stream to segment each record into sub-records. For the same operation, this turned out to be very effective in segmenting the streams into actions such as “picking up”. This is illustrated in FIG. 13. For each sub-record, we compute its motion features and visual features as follows. For the motion data, we first normalize them such that each dimension has zero mean and unit standard deviation. Then, the first-order difference is computed, which gives the spatial/angular movements of the hand. To alleviate the impact of noise or irrelevant motion of an idling hand, we propose to model the video data by using the histogram of optical flow (HoF). HoF has been shown to be useful in action recognition tasks. Specifically, we first compute the optical flow for each frame and then we divide the optical flow into 8 bins, according to their orientation, and cumulate the magnitudes of optical flows of each bin, followed by normalization.

With the above preparation, we learn the latent space for the video data by applying CCA between the video stream and the motion data stream. Formally, given the extracted HoF feature matrix Sₓ∈R^{n×d} and the first-order difference of motion data S_{y}∈R^{n×k} of all the training records, we use CCA to find the projection matrices wₓ and w_{y} by

$$ρ = {max}_{{w}_{x} {w}_{y}} corr ( {S}_{x} {w}_{x} , {S}_{y} {w}_{y} ) = {max}_{{w}_{x} {w}_{y}} \frac{〈 {S}_{x} {w}_{x} , {S}_{y} {w}_{y} 〉}{‖ {S}_{x} {w}_{x} ‖ ‖ {S}_{y} {w}_{y} ‖} \qquad ( 1 )$$

where n is the number of frames of the video stream or motion stream, d is the dimension of HoF vector and k is the dimension of the motion data feature. In the latent space, we care more about the top few dimensions on which the correlation of the input streams are strong.

To demonstrate that the above approach is able to lead to a feature space that is appropriate for skill analysis, we carried out several evaluation experiments, as elaborated below. We made a reasonable assumption that the subjects would improve their skill over the 4-week period since they were required to practice for 3 sessions each week. With this, if we look at the data from the first week and that from the last week, we would observe the most obvious difference of skill if any. In the first experiment, we analyzed the acceleration computed from the records. This reflects the force the subjects applied during the surgical operation. For the video data, the acceleration was computed as the first-order difference of the original feature, and for the motion tracker data, the second order difference was computed as the acceleration. In implementation, we adopted the root-mean-square (RMS) error between adjacent frames in computing the acceleration.

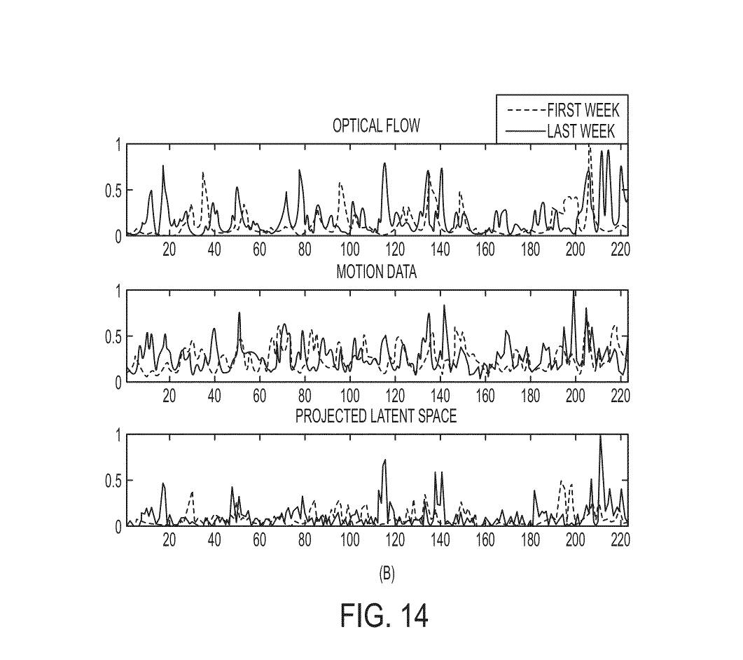

FIG. 14 illustrates the RMS for 200 frames of a record. In the top plot, i.e., the original optical flow data, there is no apparent difference between the first week (the dotted curve) and the last week (the solid curve). However, in the motion data modality (the middle plot), we observe that the acceleration of the last week is greater than the first week. After projecting the optical flow data into the learned latent space by our proposed approach (the bottom plot), the differences of the acceleration between the first week and the last week become more obvious. This suggests that, in the latent space, even if we only use the video data, we may still be able to detect meaningful cues for facilitating the inference of surgical skills.

We also computed the area under the curves in FIG. 14, which can be used to describe the energy (of acceleration) used during the operation. This is documented in the table of Table 1, for all the records of each subject. These results were computed via the leave-one-out scheme: We used the records of nine subjects as the training data to learn the latent space, and then project the data of the tenth subject (as the testing data) into the learned latent space and compute the area under curve as the energy; finally, we subtracted the average energy of the records of the first week from that of the last week for the tenth subject. We shuffled the order of the subjects, such that records of each subject are used once as the testing data. The results shown in Table 1 suggest that the difference in the latent space is enlarged, implying that the acceleration metric is enhanced in the latent space. Further, the leave-one-out scheme also suggests that the analysis is not tuned only for any specific subject, but is instead general in nature.

TABLE 1
The difference of
averaged RMS between records of the last week and those of the first week for different subjects.

| Subject | 1 | 2 | 3 | 4 | 5 | 6 | 7 | 8 | 9 | 10 |
|---|---|---|---|---|---|---|---|---|---|---|
| Optical Flow | 3.15 | 0.03 | 3.32 | 2.98 | 1.00 | 2.50 | 2.40 | 1.67 | 0.74 | −0.61 |
| Latent Space | 3.90 | 0.58 | 4.86 | 4.03 | 1.70 | 3.27 | 2.71 | 2.71 | 1.90 | 0.30 |

TABLE 2
Classification accuracy of different classifiers,
using the original optical flow feature and the new latent space respectively.

| | LinearSVM | PolynomialSVM | AdaBoost |
|---|---|---|---|
| Raw Optical Flow | 0.74 | 0.70 | 0.71 |
| Latent Space Data | 0.78 | 0.79 | 0.79 |

Finally, we used a classification framework to demonstrate that the learned latent space supports better analysis of surgical skills. Based on our assumption, we treated the videos captured in the first week as the novice class (Class 1) and those from the last week as the expert class (Class 2). Then we used the Bag-of-Word (BoW) model to encode the HoF features for representing the videos. For classification, we experimented with kernel-SVM and Adaboost. We applied the leave-one-subject-out cross-validation: we left out both the first and last week of videos from one subject for test, and used the others for training the classifier. The results of the experiment were summarized in Table 2. The results clearly suggest that the classification accuracy in the latent space was consistently higher than that using the original space, demonstrating that the learned latent space supports better analysis of surgical skills.

There are a set of standard operations defined for the FLS training system. For clarity of presentation, the subsequent discussion (including experiments) will focus on only one operation termed “Peg Transfer” (illustrated in FIG. 11a). In the operation, a trainee is required to lift one of the six objects with a grasper in his non-dominant hand, transfer the object midair to his dominant hand, and then place the object on a peg on the other side of the board. Once all six objects have been transferred, the process is reversed from one side to the other.

The Peg Transfer operation consists of several primitive actions or ‘therbligs’ as building blocks of manipulative surgical activities, which are defined in Table 3. Ideally, these primitive actions are all necessary in order to finish one peg-transfer cycle. Since there are six objects to transfer from left to right and backwards, there are totally 12 cycles in one training session. Our experiments are based on video recordings (FIG. 1, right) from the FLS system on-board camera capturing training sessions of resident surgeons in their different residency years.

TABLE 3
Primitive actions with abbreviations in Peg Transfer.

| Name | Description |
|---|---|
| Lift (L) | Grasp an object and lift it off a peg |
| Transfer (T) | Object transfer from one hand to |
| | another |
| Place (P) | Release an object and place it on a |
| | peg |
| Loaded | Move a grasper with an object |
| Move (LM) | |
| Unloaded | Move a grasper without any object |
| Move (UM) | |

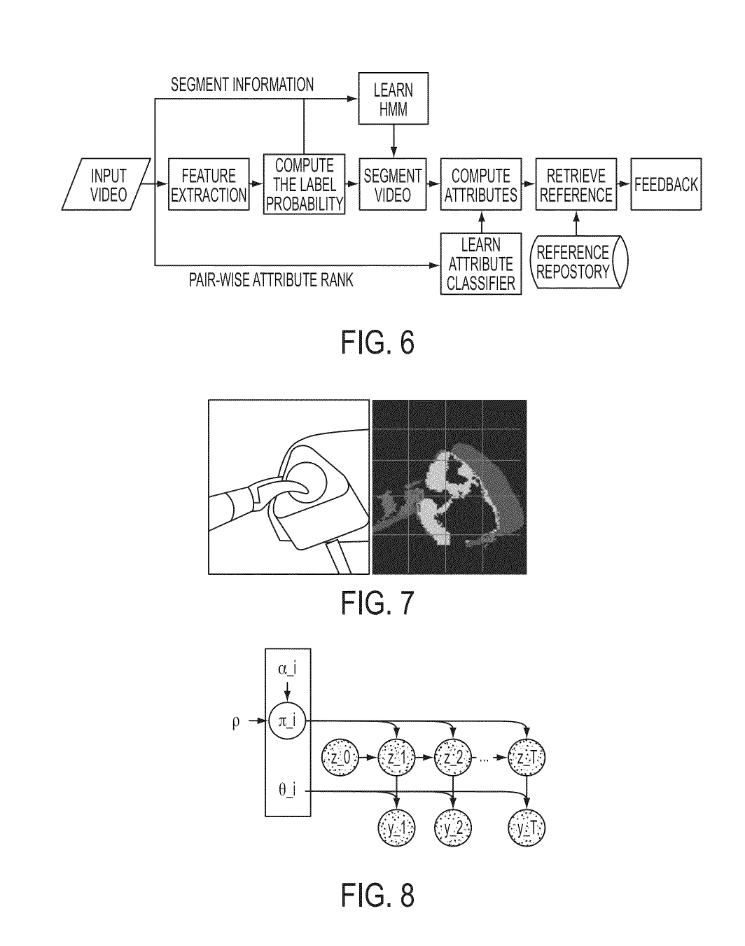

Further details regarding the algorithms for the disclosed method for video-based skill coaching will now be disclosed. Suppose that a user has just finished a training session on the FLS box and a video recording is available for analysis. The system needs to perform the three tasks as discussed above order to deliver automated feedback to the user. FIG. 6 presents a flow chart of our system, outlining its major algorithmic components and their interactions. The green components (i.e., Learn HMM and Learn Attribute Counter) are only used in the training stage.

In the following sub-sections, we elaborate the components of the disclosed approach, organizing our presentation by the three tasks of action segmentation, action rating, and illustrative video retrieval.

### Action Segmentation

From Table 3, the videos we consider should exhibit predictable motion patterns arising from the underlying actions of the human subject. Hence we adopt the hidden Markov model (HMM) in the segmentation task.

This allows us to incorporate domain knowledge into the transition probabilities, e.g. the lift action is followed by itself or by the loaded move with high probability. Following we assume that each state represents a primitive action in the HMM. The task of segmentation is then to find the optimal state path for the given video, assuming a given HMM. This can be done with the well-known Viterbi algorithm, and thus our discussion will be given only to three new algorithmic components we designed to address several practical difficulties unique to our application: noisy video data especially due to occlusion (among the tools and objects) and reflection, limited training videos with labels, and unpredictable erroneous actions breaking the normal pattern (frequent with novice trainees).

### Frame-level Feature Extraction & Labeling

Since the FLS box is a controlled environment with strong color difference among several object labels, i.e. background, objects to move, pegs, and tools, we can use random forest (RF) to obtain the label probability Pₗ(x), 1≦l≦L for each pixel x based on its color, where L is the number of classes to consider. The color segmentation result is achieved by assigning each pixel with the label of highest probability. Based on the color segmentation result, we extract the tool tips and orientations of the two graspers controlled by the left and right hands. Since all surgical actions occur in the region around grasper tip, the region is defined as the ROI region to filter out other irrelevant background. We detect motion by image frame difference. Based on the comparison with the distribution of the background region, we estimate the probability that x belongs to a moving area, which is denoted as M(x).

With the assumption of independence between the label and motion, M(x)·Pₗ(x) is the joint distribution of motion and object label, which is deemed as important for action recognition. In fact, the multiplication with M(x) will suppress the static clutter background in the ROI so that only interested motion information will be reserved. This is illustrated in FIG. 7. Therefore, the task is how to describe the joint object-motion distribution M(x)·Pₗ(x) in the ROI for action recognition. We first split the ROI into blocks, as shown in FIG. 3. Then the object-motion distribution in each block is described by the Hu-invariant moment. Finally the moment vectors in each block are cascaded into a descriptor and fed into a random forest for (frame-level) action recognition.

### Random Forest as Observation Model

Different observation models have been proposed for HMM, including multinomial distribution (for discrete observation only) and Gaussian mixture models. These have been shown successful in some applications such as speech recognition. Such models have some deficiency for noisy video data. In certain embodiments, we use random forest as our observation model. Random forest is an ensemble classifier with a set of decision trees. The output of the random forest is based on majority voting of the trees in the forest. We train a random forest for frame-level classification and then use the output of the random forest as the observation of the HMM states. Assume that there are N trees in the forest and nᵢ decision trees assign label i to the input frame, we could view the random forest choose Label i with probability nᵢ/N which can be taken as the observation probability for State i.

### Bayesian Estimation of Transition Probability

When the state is observable, the transition probability from State i to State j can be computed as the ratio the number of (expected) transitions from State i to State j over the total number of transitions. However, one potential issue of this method is that, in video segmentation we have limited training data, and even worse the number of transitions among different states, i.e., the number of boundary frames, is typically much less than the total number of frames of the video. This will result in a transition probability matrix, whose off-diagonal elements are near zero and diagonal elements are almost one. The resulting transition probability will degrade the benefit of using HMM for video segmentation, i.e., forcing desired transition pattern in the state path.

In certain embodiments, we use a Bayesian approach for estimating the transition probability, employing the Dirichlet distribution, which enables us to combine the domain knowledge with the limited training data for the transition probability estimation. The model is shown in FIG. 8, where the states are observable for the training data. FIG. 8 illustrates a graphical model for Bayesian estimation of transition probability, where the symbols with circles are hidden variable to be estimated, the symbols within gray circle are observations and the symbols without circle are priors.

Assuming αᵢ (Σⱼαᵢ(j)=1) is our domain knowledge for the transition probabilities from State i to all states, then we can draw the transition probability vector πᵢ as:

πᵢ˜dir(ραᵢ) (2)

where dir is the Dirichlet distribution as a distribution over distribution, and ρ represents our confidence of the domain knowledge. The Dirichlet distribution always output a valid probability distribution, i.e., Σᵢπᵢ(j)=1.

Given the transition probability πᵢ, the count of transition from State i to all states follows a multinomial distribution:

$${n}_{i} \sim multi ( {n}_{i} \vert {π}_{i} ) = \frac{( {\sum }_{j} {x}_{i} ( j ) ) !}{{\prod }_{j} {n}_{i} ( j ) !} {\prod }_{j} {{π}_{i} ( j )}^{{n}_{i} ( j )} . \qquad ( 3 )$$

Because the Dirichlet distribution and multinomial distribution is a conjugate pair, the posterior probability of transition probability is just combining the count of transition among state and domain knowledge (prior) as

π˜dir(nᵢ+ραᵢ) (4)

When there are not enough training data, i.e., Σᵢnᵢ(j)<<ρ, πᵢ would be dominated by αᵢ, i.e., our domain knowledge; as more training data become available, πᵢ would approximate to the counting of transitions in the data and the variance of πᵢ would be decreasing.

### Attribute Learning for Action Rating

Segmenting the video into primitive action units only provides the opportunity of pin-pointing an error in the video, and the natural next task is to evaluate the underlying skill of an action clip. As discussed previously, high-level and abstract feedback such as a numeric score does not enable a trainee to take corrective actions. In this work, following, we define a set of attributes as listed in Table 4, and design an attribute learning algorithm for rating each primitive action with respect to the attributes. With this, the system will be able to expressively inform a trainee what is wrong in his action clip, since the attributes in Table 4 are all semantic concepts used in existing human-expert-based coaching (and thus they are well understood).

TABLE 4
Action attributes for surgical skill assessment.

| ID | Description |
|---|---|
| 1 | hands synchronization: How well two hands can |
| | work together, e.g. when one hand is operating, |
| | the other is ready to cooperate or prepare for next |
| | task. |
| 2 | Instrument handling: How well a trainee operates |
| | instruments without bad attempts or movements. |
| 3 | Suture handling: How force is controlled in |
| | operation of objects as subjective evaluation of |
| | organ damage. |
| 4 | Flow of operation: How smoothly a trainee can |
| | operate intra or inter different primitive actions. |
| 5 | Depth perception: How good a trainee's sense of |
| | depth to avoid failed operation on a wrong depth |
| | level. |

In order to cope with the practical difficult of lacking detailed and accurate labeling for the action clips, we propose to use relative attribute learning in the task of rating the clips. In this setting, we only need relative rankings of the clips with respect to the defined attributes, which is easier to obtain. Formally, for each action, we have a dataset {Vⱼ, j=1, . . . , N} of N video clips with corresponding feature vector set {vⱼ}. There are totally Kattributes defined as {Aₖ, k=1, . . . , K}. For each attribute Aₖ, we are given a set of ordered pairs of clips Oₖ={(i,j)} and a set of un-ordered pairs Sₖ={(i, j)}, where (i, j) ∈Oₖ means Vᵢ has a better skill in terms of attribute Aₖ than Vⱼ (i.e. Vᵢ>Vⱼ) and (i, j) ∈Sₖ means Vᵢ and Vⱼ have similar strength of Aₖ (i.e. (Vᵢ˜Vⱼ).

In relative attribute learning, the attributes Aₖ is computed as a linear function of the feature vector v:

rₖ(v)=wₖ^{T}·v, (5)

where weight wₖ is trained under quadratic loss function with penalties on the pairwise constraints in Oₖ and Sₖ. The cost function is quite similar to the SVM classification problem, but on pairwise difference vectors:

minimize ∥wₖ∥₂²+C·(Σε_{i,j}²+Σγ_{i,j}²)

s.t. wₖ^{T}·(vᵢ−vⱼ)≧1−ε_{i,j}; Λ(i,j)∈Oₖ, (6)

|wₖ^{T}·(vᵢ−vⱼ)|≦γ_{i,j}; Λ(i,j)∈Sₖ

ε_{i,j}≧0; γ_{i,j}≧0

where C is the trade-off constant to balance maximal margin and pairwise attribute order constraints. The success of an attribute function depends on both a good weight wₖ and a well-designed feature v.

The features used for attribute learning are outlined below. First, we extract several motion features in the region of interest (ROI) around each the grasper tip as summarized in Table 5. Then auxiliary features are extracted as defined in Table 6. These features and the execution time are combined to form the features for each action clip.

TABLE 5
Motion features around grasper tip and related attributes.

| Feature | Definition | Attribute |
|---|---|---|
| Spatial motion | dx(t)/dt | 1 − 4 |
| Radial motion | [symbol] dx(t)/dt, r(t) [symbol] | 1 |
| Relative motion | [symbol] d\hat{x}(t)/dt,\hat{r}(t) [symbol] | 3 |
| Angular motion | dθ(t)/dt | 2 |
| Optic flow | m(x,t) | 1 − 4 |

Note:
x(t) is the trajectory of grasper tip, r(t) and θ(t) are the vector and angle of grasper direction;
\hat{x}(t) is the relative motion among the two grasper tips whose relative direction is \hat{r}(t);
m(x, t) is the motion field in the ROI.

TABLE 6
Auxiliary features.

| Name | Definition | Description |
|---|---|---|
| Velocity | \|v(t)\| | Instant velocity |
| Path | ∫₀^{t}\|v(τ)\|dτ | Accumulated motion |
| | | energy |
| Jitter | \|v(t) − v̅(t)\| | Motion smoothness |
| | | metric |
| CAV | [symbol] ∇ × m,m [symbol] /∥m∥₂ | Curl angular velocity |

Note:
1) The v(t) represents any motion in Table 5 which can be vector or scalar.
2) The v̅(t) is the smooth of v(t).
3) m is the shorthand for field motion m(x, t).

### Retrieving an Illustrative Action Clip

With the above preparation, the system will retrieve an illustrative video clip from a pre-stored dataset and present it to a trainee as a reference. As this is done on a per-action basis and with explicit reference to the potentially-lagging attributes, the user can learn from watching the illustrative clip to improve his skill. With K attributes, a clip Vᵢ can be characterized by a K-dimensional vector Vᵢ: [α_{i,1}, . . . , α_{i,K}], where α_{i,k}=rₖ(vᵢ) is the k-th attribute value of Vᵢ based on its feature vector vᵢ. The attribute values of all clips (of the same action) {Vⱼ, 1≦j≦N} in the dataset forms a N×K matrix A whose column vector αₖ is the k-th attribute value of each clip. Similarly, from a user's training session, for the same action under consideration, we have another set of clips {V′ᵢ, 1≦i≦M} with corresponding M×K attribute matrix A′ whose column vector α′ₖ is the user's k-th attribute values in the training session.

The best illustration video clip V*ⱼ is selected from dataset {Vⱼ} using the following criteria:

V*ⱼ=argmaxⱼΣₖI(α′ₖ;A′,αₖ)·U(α_{j,k},α′ₖ;αₖ), (7)

where I (α′ₖ; A′, αₖ) is the attribute importance of Aₖ for the user, which is introduced to assess the user in the context of his current training session and the performance of other users on the same attribute in the given dataset. U(α_{j,k}, α′ₖ; αₖ) is the attribute utility of video Vⱼ on Aₖ for the user, which is introduced to assess how a video Vⱼ may be helpful for the user on a given attribute. The underlying idea of (3) is that a good feedback video should have high utility on important attributes. We elaborate these concepts below.

Attribute importance is the importance of an attribute Aₖ for a user's skill improvement. According to the “buckets effect”, how much water a bucket can hold, does not depend on the highest piece of wood on the sides of casks, but rather depends on the shortest piece. So a skill attribute with lower performance level should have a higher importance. We propose to measure the attribute importance of Aₖ from a user's relative performance level on two aspects. The first relative performance of Aₖ is the distribution of a user's attribute performance (α′ₖ) in the context of attribute values from people of different skill level, whose cumulative distribution function is Fₖ(α)=P (αₖ≦α). Since each element of αₖ is a sample of Aₖ over people of random skill levels, we can estimate Fₖ(α) from αₖ as a Normal distribution. Then the performance level of any attribute value αₖ of Aₖ is 1−Fₖ(αₖ). Since each element in α′ₖ is a sample of Aₖ from a user's i-th performance, the relative performance level of user on Aₖ in the context of αₖ is defined as:

I(α′ₖ;αₖ)=1−Fₖ(μ′ₖ)∈[0,1] (8)

where μ′ₖ is the mean value of α′ₖ and Fₖ(α) is the Normal cumulative distribution estimated from αₖ. Since there are totally Kattributes, the importance of Aₖ should be further considered under the performance of other attributes (A′). The final attribute importance of Aₖ is:

I(α′ₖ;A′,αₖ)=I(α′ₖ;αₖ)/Σₗ₌₁^{K}I(α′ₗ;αₗ)∈[0,1] (9)

Attribute utility is the effectiveness of a video Vⱼ for a user's skill improvement on attribute Aₖ. It can be measured by the difference between Vⱼ's attribute value α_{j,k} and a user's attribute performance α′ₖ on Aₖ. Since the dynamic range of Aₖ may vary across attributes, some normalization may be necessary. Our definition is:

U(α_{j,k},α′ₖ;αₖ)=(Fₖ(α_{j,k})−Fₖ(μ′ₖ))/(1−Fₖ(μ′ₖ)) (10)

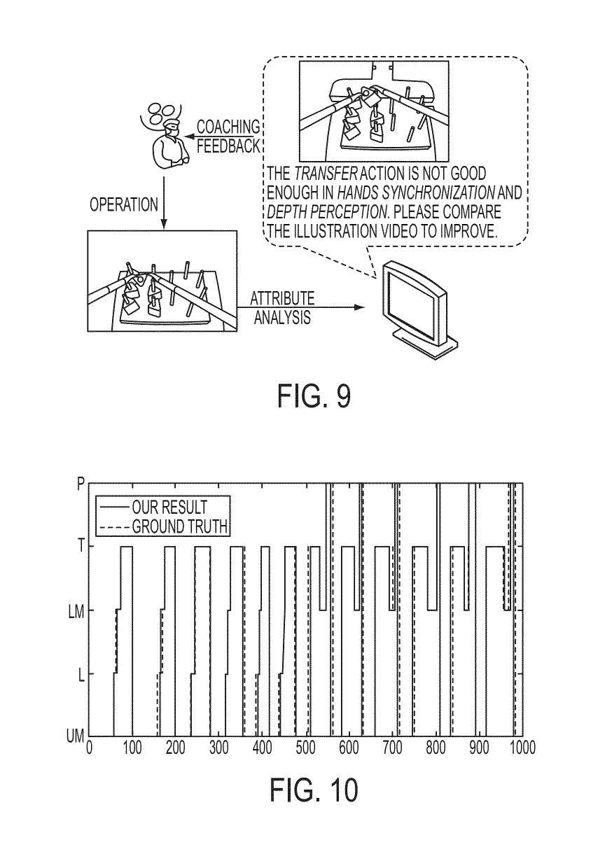

With the above attribute analysis, the system picks 3 worst action attributes with an absolute importance above a threshold 0.4, which means that more than 60 percent of the pre-stored action clips are better in this attribute than the trainee. If all attribute importance values are lower than the threshold, we simply select the worst one. With the selected attributes, we retrieve the illustration video clips, inform the trainee about on which attributes he performed poor, and direct him to the illustration video. This process is conceptually illustrated in FIG. 9.

It is worth noting that in the above process of retrieving an illustration video, we defined concepts that are concept dependent. That is, the importance and utility values of an attribute is dependent of the given data set. In practice, the data set could be a local database captured and updated frequently in a training center, or a fixed standard dataset, and thus the system allows the setting of some parameters (e.g., the threshold 0.4) based on the nature of the database.

FIG. 9 is a conceptual illustration of the proposed surgical skill coaching system that supplies an illustrative video as feedback while providing specific and expressive suggestions for making correction.

Experiments have been performed using realistic training videos capturing the performance of resident surgeons in a local hospital during their routine training on the FLS platform. For evaluating the proposed methods, we selected six representative training videos, two for each of the three skill levels: novice, intermediates, and expert. Each video is a full training session consisting of twelve Peg Transfer cycles. Since each cycle should contain of the primitive actions defined previously (Table 3), there are a total of 72 video clips for each primitive action. The exact frame-level labeling (which action each frame belongs to) were manually obtained as the ground truth for segmentation. For each primitive action, we randomly select 100 pairs of video clips and then manually label them by examining all the attributes defined in Table 4 (this process manually determines which video in a given pair should have a better skill according to a given attribute).

### Evaluating Action Segmentation

Our action segmentation method consists of two steps. First, we use the object motion distribution descriptor and the random forest to obtain an action label for each frame. Then the output of the random forest (the probability vector instead of the action label) is used as the observation of each state in an HMM and the Viterbi algorithm is used to find the best state path as final action recognition result. The confusion matrices of the two recognition steps are presented in Table 7. It can be seen that the frame-based recognition result is already high for some actions (illustrating the strength of our object motion distribution descriptor), but overall the HMM-based method gives much-improved results, especially for actions L and P. The relatively low accuracy for actions L and P is mainly because the trainee's unsmooth operation that caused many unnecessary stops and moves, which are hard to distinguish from UM and LM. We also present the recognition accuracy for each video in Table 8, which indicates that, on average, better segmentation was obtained for subjects with better skills. This also supports the discussion that various unnecessary moves and errors by novice are the main difficulty for this task. All the above recognition results were obtained from 6-fold cross-validation with 1 video left out for testing. A comparative illustration of segmentation is also given (FIG. 7). In summary, these results show that the proposed action segmentation method is able to deliver reasonable accuracy in face of some practically challenges.

TABLE 7
Confusion matrix of primitive action segmentation.

| Acc. (%) | UM | L | LM | T | P |
|---|---|---|---|---|---|
| UM | 87.6/88.0 | 0.2/0.2 | 0.6/0.8 | 11.5/10.3 | 0.8/0.8 |
| L | 21.9/36.1 | 43.4/28.5 | 21.8/15.8 | 13.0/13.3 | 0.0/6.3 |
| LM | 3.8/18.0 | 0.2/1.1 | 77.3/61.1 | 12.8/12.3 | 6.0/7.5 |
| T | 5.6/11.3 | 0.0/0.1 | 1.0/0.9 | 93.4/87.7 | 0.0/0.0 |
| P | 28.7/55.1 | 0.6/2.8 | 12.0/19.9 | 1.3/2.4 | 57.5/19.9 |

NOTE:
The abbreviations are adopted from Table 3. The accuracy percentages are for HMM/frame-based respectively.

TABLE 8
Action segmentation accuracy for each video.

| Video | 1 | 2 | 3 | 4 | 5 | 6 | Ave |
|---|---|---|---|---|---|---|---|
| Acc. (%) | 93.5 | 93.5 | 82.3 | 88.0 | 83.98 | 76.65 | 85.2 |

NOTE:
Video 1, 2 are expert;
3, 4 are intermediate;
5, 6 are novice.

FIG. 10 is a frame-level comparison of action segmentation of a trainee's left-hand operation in video 1 (Table 8) with 12 circles.

### Evaluating Relative Attribute Learning

Validity is an important characteristic in skill assessment. This refers to the extent to which a test measures the trait that it purports to measure. The validity of our learned attribute evaluator can be measured by its classification accuracy on attribute order. Based on the cost function in Eqn. (6), we take the attribute Aₖ order between video pair Vᵢ and Vⱼ as Vᵢ>Vⱼ (or Vⱼ>Vᵢ) if wₖ^{T}·(vᵢ−vⱼ) is ≧1 or ≦−1), and Vᵢ˜Vⱼ if |wₖ^{T}·(vᵢ−vⱼ)|<1. The classification accuracy of each attribute is derived by 10-fold cross validation on the 100 labeled pairs in each primitive action, as given in Table 9. The good accuracy in the table demonstrates that our attribute evaluator, albeit learned only from relative information, has a high validity. In this experiment, only 3 primitive actions were considered here, i.e. L, T, and P, since they are the main operation action and the other LM and UM actions are just preparation for the operation. Also, some attributes are ignored for some actions as they are inappropriate for skill assessment for those actions. These correspond to the “N/A” entries in Table 9.

TABLE 9
Accuracy of attribute learning across primitive actions.

| | Hand | Instrument | Suture | Flow of | Depth |
|---|---|---|---|---|---|
| | sync. | handling | handling | operation | perception |
| L | N/A | 92% | 91% | N/A | 86% |
| T | 82% | 85% | N/A | 88% | 80% |
| P | N/A | 97% | 91% | N/A | 100% |

### Evaluating Illustrative Video Feedback

We compared our video feedback method (Eqn. (7)) with a baseline method that randomly selects one expert video clip of the primitive action. The comparison protocol is as follows. We recruited 12 subjects who had no prior knowledge on the dataset. For each testing video, we randomly select 1 action clip for each primitive action. Then for each attribute, one feedback video is obtained by either our method or the baseline method. The subjects are asked to select which one is a better instruction video for skill improvement, for the given attribute. The subjective test result is summarized in Table 10, which shows that people think our feedback is better or comparable to the baseline feedback in 77.5% cases. The satisfactory rate can be as high as 83.3% and 80% in hand synchronization and suture handling which shows our attribute learning scheme has high validity in this two attributes. This is also consistent with the cross-validation result in Table 9. The result is especially satisfactory since the baseline method already employs an expert video (and thus our method is able to tell which expert video clip is more useful to serve as an illustrative reference).

TABLE 10
Subjective test on feedback video illustration

| | Hand | Instrument | Suture | Flow of | Depth |
|---|---|---|---|---|---|
| | sync. | handling | handling | operation | perception |
| L | N/A | 2/1/5 | 6/2/0 | N/A | N/A |
| T | 7/3/2 | N/A | N/A | 7/1/4 | N/A |
| P | N/A | 10/2/0 | 6/2/4 | N/A | N/A |

Note:
In each cell is the number of tests that the experimenters think our feedback to be better/similar/worse to the baseline.

1. A method of providing training comprising:
receiving at least one video stream from a video camera observing a trainee's movements;
extract skill-related attributes from the at least one video stream to; and
displaying the video stream and the skill-related attributes.

2. The method of claim 1, wherein the skill-related attributes are displayed on a display in real-time.

3. The method of claim 1, further comprising:
receiving at least one data stream from a data glove; and
extracting skill-related attributes from the at least one data stream.

4. The method claim 3, further comprising
receiving at least one data stream from a motion tracker; and
extract skill-related attributes from the at least one data stream.

5. The method of claim 1, wherein the extracted attributes comprise motion features in a region of interest.

6. The method of claim 5, wherein the motion features comprise spatial motion, radial motion, relative motion, angular motion and optic flow.

7. The method of claim 1, wherein the extracting step utilizes a random forest model.

8. An apparatus for training a trainee, comprising:
a laparoscopic surgery simulation system having a first camera and a video monitor;
a second camera for capturing a trainee's hand movement; and
a computer for receiving video streams from the first and second cameras, the computer having a processor configured to extract skill-related attributes video streams to extract.

9. The apparatus of claim 8, further comprising kinematic sensors for capturing kinematics of the hands and fingers.

10. The apparatus of claim 9, wherein the kinematic sensor comprises a motion tracker.

11. The apparatus of claim 9, wherein the kinematic sensor comprises a data glove.

12. The apparatus of claim 9, wherein the skill-related attributes comprise smoothness of motion and acceleration.

13. A method of providing instructive feedback comprising:
decomposing a video sequence of a training procedure into primitive action units; and
rating each action unit using expressive attributes derived from established guidelines.

14. The method of claim 13, further comprising selecting an illustrative video as a reference from a pre-stored database.

15. The method of claim 13, further comprising storing a trainee's practice sessions of the training procedure.

16. The method of claim 15, further comprising comparing different trainee practice sessions of the training procedure.

17. The method of claim 13, further comprising providing offline feedback.

18. The method of claim 13, further comprising providing live feedback.

19. The method of claim 13, wherein the expressive attributes are selected from the group comprising hands synchronization, instrument handling, suture handling, flow of operation and depth perception.

20. The method of claim 13, further comprising:
identifying worst action attributes of a trainee;
retrieving illustration video clips relating to the worst action attributes; and
presenting the illustration video clips to the trainee.
